(19) United States
(12) Patent Application Publication
(10) Pub. No.: US 2002/0047262 A1
(43) Pub. Date: Apr. 25, 2002

(54) Holographic images

(76) Inventor: Steen Vesborg, Gentofte (DK)

Correspondence Address: COLGATE-PALMOLIVE COMPANY, 909 RIVER ROAD, PISCATAWAY, NJ, 08855, US

(21) Appl. No.: 09/950,910

(22) Filed: Sep. 12, 2001

Related U.S. Application Data
(60) Provisional application No. 60/232,351, filed on Sep. 14, 2000.

(51) Int. Cl. G03H 1/02

(52) U.S. Cl. 283/86; 430/2; 430/1; 359/2

(57) ABSTRACT

It has been found that holographic images can be formed on the surfaces of plastic products or the plastic packaging for products. The elastic preferably is a thermoplastic that can flow into the narrow spacings that form the holographic image. The holographic image is formed while the product or packaging is being formed. These can be formed by injection molding, blowmolding, injection stretch blowmolding and thermoforming. A shim bearing the image of the hologram is placed in the mold and the plastic injected or otherwise flowed or placed in the mold. Upon the plastic under pressure being in contact with the shin in the mold, the shin will impart a holographic image into the plastic. The product or package is cooled and then is in a form for use.

### FIELD OF THE INVENTION

This invention relates to molded holographic images. More particularly, this invention relates to molded plastic holographic images that can be used as a part of a product or for the packaging for a product.

### BACKGROUND OF THE INVENTION

Holography is a technique of photography in which a wave field of light scattered by an object is recorded as an interference pattern. When the photographic record, also known as a hologram, is regenerated, the observer will see a three-dimensional image that is a perfect likeness of the of the original object.

In recording a holographic image both the intensity or amplitude of the reflected light and the phase of this reflected light must be recorded. The intensity is readily recorded with this being easily perceived by the eye or photographic film. This is the brightness. However, to record the phase of this light require the process of interferometry. The phase must be converted to intensity so that it can be recorded and/or perceived by the human eye. When coherent light, i.e. a monochromatic source is reflected off of an object a spherical wave pattern is formed. When this spherical wave is combined with a plane wave of the same coherent light, there is an interference of the spherical wave and the plane wave. A fringe pattern results caused by this interference. The spacing of the fringe pattern records the phase of the light. The amplitude or intensity is represented by the contrast of the fringes. In this way the image formed is a holographic image where both the amplitude and phase of the reflected light can be reconstructed by light that is reflected off of the holographic image. The incident and reflected light to regenerate the image need not be a coherent light source to provide a three-dimensional image that is a perfect likeness of the original object.

The present invention is directed to the molding of holograms directly onto a package. This can be by injection molding, blow molding, injection stretch blow molding, thermoforming or some other molding technique. A shim having the design of the desired hologram will be a part of the mold. It will be a negative of the hologram that is to be on the molded item. The molded item will be a bottle, dispenser, box, container or other carrier for a primary product. However, the molded item also can be the primary product. The molded item is constructed of a moldable plastic, usually a thermoplastic. However, thermoset plastics can be used.

### BRIEF SUMMARY OF THE INVENTION

This invention is directed to molding holographic images directly onto packaging for products. The packaging will be constructed of a thermoplastic or thermoset material and will have the hologram as an integral part of the container, bottle, box, dispenser or other package for a primary product. The holographic image also can be a part or a component of a primary product package such as a dispenser inclusive of a closure or pump head. This is distinctly different from a holographic label on a package. Here the hologram is an integral part of the package.

The hologram also can be an integral part of a primary product such as handle such as for a kitchen utensil, hair comb, toothbrush or the like. A hologram can be put into essentially any material that is molded out of a plastic.

The hologram is produced as an integral part of the package or primary product by a negative of the hologram being formed on a shim. The shim then is secured to the mold by an adhesive, soldering, welding, through the use of fasteners or an equivalent technique. Once a part of the mold, a positive image of the hologram will be formed on the surface of the package or primary product as the package or primary product is formed, usually by a molding technique. Useful molding techniques are injection molding, thermoforming, blow molding, stretch blow molding and injection stretch blow molding. Upon viewing the part of the package with the hologram there is reproduced a three-dimensional depiction of the original image.

This three-dimensional image can be a logo, product name, source name, scenic picture, portrait, or other writing or pictorial or some sort of diffraction grating. By being a holographic image the image is more attractive and will better attract a person to focus on that package or product. And by being an integral part of the package or product, the hologram is more easily manufactured and is not as susceptible to damage as are labels. Further, it will be less costly to form the hologram at the time of forming the package.

A wide range of plastics can be used as the base for the hologram. These primarily are thermoplastics and include polyolefin, polyesters, polyamid, polycarbonates, liquid crystal, polymers, styrenebetadiene polymers and compounded surylyn alloy polymers. The mold conditions will depend to a large degree on the base polymers but with the temperature being about 20° C. to about 90° C., a polymer temperature of about 75° C. to about 300° C., a fill pressure about 800 psi to about 1400 psi, and cycle time about 10 seconds to about 35 seconds. The cure time is about 10 seconds to about 25 seconds.

It has been found that improved holograms are formed when the polymer resin is pigmented, with darker pigments providing a greater improvement. Further, the higher the resin modulus and lower the intrinsic viscosity, the better the hologram image.

### DETAILED DESCRIPTION OF THE INVENTION

It is advantageous to form a hologram as an integral part of a package rather than applying a holographic label to a package. In this way the hologram is an integral part of the package. It is more efficient to form the hologram as the package is being formed.

The package can be any enclosure, or substantial enclosure, for a primary product. This can be a container, bottle, box, dispenser or a component of any of these packages. The package is formed by molding such as injection molding, thermoforming, injection blow molding or injection stretch blow molding. The package materials are plastics, inclusive of thermoplastic or thermoset plastics. In such molding processes a shim that carries the holographic image is secured into a mold. This can be through the use of an adhesive, soldering, welding or through the use of fasteners.

The shim is a metal which usually will be a hard metal such as steel, chromium, nickel, tantalum and palladium. A hard metal is needed so that the shim will effectively produce large volumes of molded packages or package parts.

One technique to make a shim is to have a photoresist on a glass backing support. The photoresist is exposed to an image through interferometry. That is, the photoresist receives a beam of coherent light directly and reflected by an image. There is an interference of the two light beams which produces a fringe pattern on the photoresist. Where light strikes the photoresist, the polymer is polymerized. The glass/photoresist then undergoes a caustic (sodium hydroxide) wash to remove the unreacted plastic of the photoresist. This is followed by an etching of the exposed glass surface with hydrogen fluoride. Subsequently, the polymerized plastic is removed using a solvent for this polymerized plastic. A metal such as nickel, copper, platinum, tantalum, tungsten, molybdenum or chromium then is deposited onto the area of the glass plate that has been etched. This produces a thin metal layer with the holographic image. This can be attached to a metal backing to yield the shim that can be secured in a mold.

There are various techniques that can be used to enhance the molding of holographic images onto plastic packaging. In thermoforming, the side of the plastic sheet that will be adjacent the mold should be at a higher temperature than the other surface. In this way the plastic will flow better into the interstices of the shim for a better replication of the holographic image in the plastic.

Injection molding can be by reciprocating screw injection molding or screw preplasticator injection molding. Each technique comprises the injection of a molten plastic into a mold under a fill pressure of about 800 psi to about 1,400 psi, a pack pressure of about 500 psi to about 1,500 psi and a hold pressure of about 400 psi to about 1,400 psi. the mold temperature is about 20° C. to about 90° C. The molten plastic will flow into all of the interstices of the mold. This includes into the interstices of any holographic shim that is a part of the mold. It is for this reason that the plastic should have a low intrinsic viscosity, preferably about 0.75 dL/g or lower. Prior to injection into the mold, the plastic will be heated to a temperature below the range where any substantial decomposition can occur, to about a temperature of about 75° C. to about 300° C. depending on the plastic material. A significant amount of the heat also is generated by the shear of the plastic during high pressure extrusion of the plastic and must be considered in the preheating of the plastic. This heat reduces the viscosity of the molten plastic. The total cycle time of molding is about 10 seconds to about 35 seconds with a cure time of about 10 seconds to about 25 seconds. The plastic in the mold formed to given shape is allowed to cool and to solidify prior to the opening of the mold and the ejection of the molded article.

Blow molding of articles can be by any one of three techniques. These are extrusion blow molding, injection blow molding and injection stretch blow molding. In extrusion blow molding a parison is extruded and the mold closed pinching off the lower end to close this lower end. As the mold closes the upper end is held of the mold and a blow pin is inserted into the neck. An air pressure of about 7 kg/cm² to about 40 kg/cm² expands the parison of molten plastic out to the mold walls. The exterior plastic wall will adopt the shape of the mold wall. When the shim with the negative of the holographic image is a part of the exterior, this holographic image will be a part of the wall of the article.

In injection blow molding a parison is injection molded around a core pin. This hot plastic on the core pin is indexed in the mold where it is blown at high pressure to the shape of the mold. The blowing pressures are the same as for extrusion blow molding. Like in extrusion blow molding, a shim having the holographic image can be a part of the mold. This holographic image will then be part of the exterior surface of the article, which usually is a bottle.

A variation on injection blow molding is injection stretch blow molding. In this technique prior to, or simultaneous with, the blowing of the article to the shape of the mold, a stretch pin extends the parison to adjacent the bottom of the mold. This produces a biaxially oriented material as the walls of the article will have the shape of the mold including a positive image of any shim having the negative of a holographic image.

Another type of useful molding is thermoform molding. In this technique two sheets of plastic are heated and by an over pressure and/or a vacuum caused to contact the surfaces of a mold. The two sheets also are bonded together along a substantial portion of their periphery. When a skim having a negative of a holographic image is a part of the mold, a holographic image will be formed on the surface of the thermoformed article. In a preferred embodiment the surfaces of the sheets of plastic that are to contact the mold wall are higher than the other surfaces so that the plastic will more readily flow into the interstices of the mold. These include the interstices of the shim.

The plastics that can be used in these molding techniques include any the thermoplastics and thermoset materials like phenolics. The preferred plastics include but are not limited to:

polyolefin polymers and copolymers of ethylene, propylene, butene, butylene, vinyl alcohol, and vinyl acetate;

polyesters and copolyesters of polyethylene terephthalate (PET) resins;

polyesters and copolyesters of amorphous polyethylene terephthalate (APET) resins;

polyesters and copolyesters of polyethylene naphthalate (PEN) resins;

polyesters and copolyesters of polybutylene terephthalate (PBT) resins;

styrene and/or butadiene polymers and copolymers;

polyamid polymers and copolymers (nylon family);

thermoplastic elastomers;

polycarbonates; and

liquid crystal polymers.

In order to produce better holograms the plastics should be pigmented, preferably with a dark pigment. Further, for the ease of flow of the plastic in the mold, the plastic should have a low intrinsic viscosity and a high resin modulus. This will produce a more striking holographic image in the plastic surface.

What is claimed is:

1. A plastic package having a hologram image molded as an integral section of a surface thereof.

2. A plastic package as in claim 1 wherein the plastic comprising said package is a thermoplastic.

3. A plastic package as in claim 1 wherein the plastic comprising said package is a thermoset plastic.

4. A plastic package as in claim 1 wherein the surface bearing the hologram image is the surface of a closure of the package.

5. A plastic package as in claim 1 wherein said package is a container.

6. A plastic package as in claim 5 wherein said container is a bottle.

7. A plastic package as in claim 1 wherein said package is a dispenser.

8. A plastic package as in claim 1 wherein the surface bearing said hologram is planar.

9. A plastic package as in claim 1 wherein the surface bearing said hologram is curved.

10. A plastic package as in claim 1 wherein said package is a thermoformed package.
